(19) United States
(12) Patent Application Publication
(10) Pub. No.: US 2019/0300708 A1
(43) Pub. Date: Oct. 3, 2019

(54) METHOD FOR INCREASING RESISTANCE TO HALOGEN-CONTAINING OXIDIZING AGENTS OF A POLYAMIDE COMPOSITION

(71) Applicant: Rhodia Operations, Paris (FR)

(72) Inventors: Soumyadeb Ghosh, Gujarat (IN); Hemang Darji, Vadodara (IN); Franco Enrico Speroni, Ceriano Laghetto (MB) (IT); Thomas Barraud, Lyon (FR)

(73) Assignee: Rhodia Operations, Paris (FR)

(21) Appl. No.: 16/317,384

(22) PCT Filed: Jul. 12, 2017
(86) PCT No.: PCT/EP2017/067595

§ 371 Date: Jan. 11, 2019

(30) Foreign Application Priority Data
Jul. 13, 2016 (IN) 201621023980

(51) Int. Cl. C08L 77/02; C08L 77/06; C08L 61/06; C08K 5/00; C08K 3/013; C08K 7/14; C08J 5/04

(52) U.S. Cl. CPC C08L 77/02; C08L 77/06; C08L 61/06; C08K 5/005; C08K 3/013; C08J 2461/10; C08J 5/043; C08J 5/044; C08J 5/046; C08J 2377/06; C08K 7/14

(57) ABSTRACT

A method for increasing a polyamide-containing composition's resistance to halogen-containing oxidizing agents includes blending the polyamide with at least one phenol-carbonyl condensation product. An article may be manufactured from a composition that includes at least one polyamide and at least one phenol-carbonyl condensation product, the article having a shape that permits it to contain, store and/or transport a liquid.

This application claims priority to Indian provisional application No. IN201621023980 filed Jul. 13, 2016, the whole content of this application being incorporated herein by reference for all purposes.

The present invention concerns a method for increasing resistance to halogen-containing oxidizing agents of a composition comprising at least one polyamide comprising at least the step of blending the polyamide with at least one phenol-carbonyl condensation product. The invention also concerns articles manufactured from a composition comprising at least one polyamide and at least one phenol-carbonyl condensation product, having a shape permitting to contain, store and/or transport a liquid.

### PRIOR ART

Polyamide-based thermoplastic compositions are raw materials that can be converted to plastic articles and parts, especially via various forming processes.

Polyamides have poor resistance to halogen-containing oxidizing agents, such as diatomic halogens, halogen oxides, halogen radicals, halogen amines and/or halogen oxoanion salts or their precursors, particularly to sodium hypochlorite. They lose strength after being in contact with sodium hypochlorite solution for a few hours and an important degradation of surface aspect occurs at the surface of the articles made of polyamides.

In many fields of activity, it may prove necessary to be able to provide materials that have high mechanical properties and also a high resistance to halogen-containing oxidizing agents. As an application, mention may especially be made of the pipes and tanks in the plumbing field.

However, in view of the temperatures exerted on the polyamide in certain applications, especially in the plumbing field, it is difficult to find formulations, especially based on conventional polyamides, which have good resistance to halogen-containing oxidizing agents and which make it possible to meet the specifications for this application.

### INVENTION

The Applicant has discovered, entirely surprisingly, that the use of a phenol-carbonyl condensation product in a polyamide-based composition makes it possible to increase its resistance to halogen-containing oxidizing agents.

The main subject of the present invention is a method for increasing resistance to halogen-containing oxidizing agents of a composition comprising at least one polyamide comprising at least the step of blending the polyamide with at least one phenol-carbonyl condensation product. The invention also concerns the use of a phenol-carbonyl condensation product for increasing resistance to halogen-containing oxidizing agents of a polyamide composition to improve its mechanical properties, notably tensile strength retention after ageing in chlorinated water.

The invention also concerns the use of a composition comprising at least one polyamide and at least one phenol-carbonyl condensation product, said composition having higher resistance to halogen-containing oxidizing agents, notably an improved tensile strength retention after ageing in chlorinated water.

The invention also concerns an article manufactured from a composition comprising at least one polyamide and at least one phenol-carbonyl condensation product, having a shape permitting to contain, store and/or transport a liquid.

Should the disclosure of any patents, patent applications, and publications which are incorporated herein by reference conflict with the description of the present application to the extent that it may render a term unclear, the present description shall take precedence.

Other characteristics, details and advantages of the invention will emerge even more fully upon reading the description which follows.

### Definition

Throughout the description, including the claims, the term “comprising one” should be understood as being synonymous with the term “comprising at least one”, unless otherwise specified, and “between” should be understood as being inclusive of the limits.

The term “and/or” includes the meanings “and”, “or” and also all the other possible combinations of the elements connected to this term.

It should be noted that in specifying any range of concentration, any particular upper concentration can be associated with any particular lower concentration.

It is specified that, in the continuation of the description, unless otherwise indicated, the values at the limits are included in the ranges of values which are given.

The term “aromatic group” includes aromatic hydrocarbon groups and/or heterocyclic aromatic groups. Heterocyclic aromatic groups include those containing oxygen, nitrogen, or sulphur (such as those groups derived from furan, pyrazole or thiazole). Aromatic groups can be monocyclic (for example as in benzene), bicyclic (for example as in naphthalene), or polycyclic (for example as in anthracene). Monocyclic aromatic groups include five-membered rings (such as those derived from pyrrole) or six-membered rings (such as those derived from pyridine). The aromatic groups may comprise fused aromatic groups comprising rings that share their connecting bonds.

### DETAILS OF THE INVENTION

As polyamides that may be used according to the invention, mention may be made of semicrystalline or amorphous (co)polyamides, ie. polyamides or copolyamides, such as aliphatic polyamides, semiaromatic polyamides and, more generally, linear polyamides obtained by polycondensation between a saturated aliphatic or aromatic diacid and a saturated aliphatic or aromatic primary diamine, polyamides obtained by condensation of a lactam or an amino acid, or linear polyamides obtained by condensation of a mixture of these various monomers. More specifically, these copolyamides may be, for example, polyhexamethylene adipamide, polyphthalamides obtained from terephthalic and/or isophthalic acid, and copolyamides obtained from adipic acid, hexamethylenediamine and caprolactam.

Preferably the polyamide is selected from the group consisting of
the polyamides obtained by polycondensation of:
at least one aliphatic, cycloaliphatic or aromatic diacid with at least one aliphatic, cycloaliphatic or aromatic diamine,
at least one amino acid to itself, the amino acid preferably being an omega aminoacid generated by opening of a lactam ring, or
copolyamides obtained by the polycondensation of combinations of said diacid, diamine and/or aminoacid.

At least one of the diacid, diamine and/or aminoacid monomer used in the polycondensation may comprise between 2 and 40 carbon atoms.

Polyamides are preferably chosen from the group consisting of (co)polyamides as follows: polyamide 6, polyamide 7, polyamide 6.6, polyamide 10, polyamide 11, polyamide 12, polyamide 6.9, polyamide 5.10, polyamide 6.10, polyamide 6.12, polyamide 6.14, polyamide 10.10, polyamide 10.12, polyamide 10.14, polyamide 10.18, polyamide 12.12, polyamide 4.6, polyamide 6.18, polyamide 6.36, polyamide 9.T, polyamide MXD6, polyamide 6.6/6.T, polyamide 6.6/MPMD.T, (MPMD=methyl-pentamethylenediamine), polyamide 6.6/6.1 and blends and copolymers based on these polyamides.

The composition of the invention may also comprise copolyamides derived especially from the above polyamides, or blends of these polyamides or copolyamides.

The preferred polyamides are polyhexamethylene adipamide, polycaprolactam, or copolymers and blends of polyhexamethylene adipamide and polycaprolactam.

Polyamides whose molecular weights are suited to injection-molding processes, for example with a viscosity index VI of between 80 and 200 ml/g, and most prefereably between 100 and 160 ml/g, according to standard ISO 307, are generally used; however, polyamides of lower viscosity may also be used.

The polyamide may especially be a polymer comprising star-shaped or H-shaped macromolecular chains and, where appropriate, linear macromolecular chains. Polymers comprising such star-shaped or H-shaped macromolecular chains are described, for example, in documents FR 2743077, FR 2779730, U.S. Pat. No. 5,959,069, EP 0632703, EP 0682057 and EP 0832149.

According to another particular variant of the invention, the polyamide of the invention may be a polymer of random tree type, preferably a copolyamide having a random tree structure. These copolyamides of random tree structure and the process for obtaining them are described especially in document WO 99/03909. The polyamide may also be a blend comprising a linear thermoplastic polymer and a star-shaped, H-shaped and/or tree-type thermoplastic polymer as described above. The composition of the invention may also comprise a hyperbranched copolyamide of the type of those described in document WO 00/68298. The composition of the invention may also comprise any combination of linear, star-shaped, H-shaped and tree-type thermoplastic polymers or hyperbranched copolyamides as described above.

The composition according to the invention preferentially contains from 30 to 90% by weight of polyamide, relative to the total weight of the composition.

Phenol-carbonyl condensation products are preferably chosen from the group consisting of: phenol-aldehyde condensation products and phenol-ketone condensation products.

Phenol-aldehyde or phenol-ketone condensation products are condensation products of phenolic compounds with aldehydes or ketones; in particular a condensation product of at least one phenolic compound with at least one aldehyde and/or one ketone. These condensation reactions are generally catalyzed with an acid or a base.

The phenolic compounds may be chosen, alone or as a mixture, from phenol, cresol, xylenol, naphthol, alkylphenols, such as butylphenol, tert-butylphenol, isooctylphenol, nitrophenol, phenylphenol, resorcinol or bisphenol A; or any other substituted phenol.

The aldehyde used most frequently is formaldehyde. However, others may be used, such as acetaldehyde, para-formaldehyde (polyoxymethylene), butyraldehyde, crotonaldehyde, glycoxal and furfural.

As ketone, it is possible to use acetone, methyl ethyl ketone or acetophenone.

According to one particular embodiment of the invention, the phenol-aldehyde condensation product is a condensation product of phenol and formaldehyde.

Preferably, the phenol-carbonyl condensation product is a novolac resin or a resole resin.

Novolacs are phenol-formaldehyde resins with a formaldehyde to phenol molar ratio of less than one. The polymerization is brought to completion using acid-catalysis such as oxalic acid, hydrochloric acid or sulfonate acids. The phenol units are mainly linked by methylene and/or ether groups.

Resole are base-catalysed phenol-formaldehyde resins made with a formaldehyde to phenol ratio of greater than one (usually around 1.5). Phenol, formaldehyde, water and catalyst are usually mixed in the desired amount, depending on the resin to be formed, and are then heated. The first part of the reaction, at around 70° C., forms a thick reddish-brown tacky material, which is rich in hydroxymethyl and benzylic ether groups.

The composition according to the invention may comprise one or more different types of novolac resin.

Phenol-carbonyl condensation products are generally have a degree of condensation between 2 and 15. The novolac resins preferably have a degree of condensation between 2 and 15.

Phenol-carbonyl condensation products may have an average molecular weight comprised between 500 and 10000 g/mol, preferably between 500 and 3000 g/mol. It may be measured by gel permeation chromatography (GPC) or by other techniques commonly used by person skilled in the art, as it is well described in Determination of Molecular Weight Distributions of Novolac Resins by Gel Permeation Chromatography, T. R. Dargaville et al., 1996.

The novolac resins used advantageously have an average molecular weight comprised between 500 and 3000 g/mol, preferably between 800 and 2000 g/mol.

As commercial novolac resin, mention may especially be made of the commercial products Durez®, Vulkadur®, Rhenosin® or Nowolac®.

The composition of the invention may comprise from 0.1% to 30% by weight, preferably from 1 to 20% by weight, notably from 1 to 10% by weight, of the phenol-carbonyl condensation product relative to the total weight of the polyamide and the phenol-carbonyl condensation product.

The composition may comprise from 70% to 99.9% by weight, preferably from 80 to 99% by weight, of the polyamide relative to the total weight of the polyamide and the phenol-carbonyl condensation product.

Blending of at least one polyamide with at least one phenol-carbonyl condensation product may be carried out according to several methods such as for instance:
Dry blending of at least one polyamide with at least one phenol-carbonyl condensation product, notably in a mechanical mixer, the solid mixture being then melted, for example via an extrusion process.
Blending of at least one polyamide with at least one phenol-carbonyl condensation product in melt, especially by melt compounding during a step of extrusion of the polyamide. Other melt-compounding methods batch-mixing on a Bradender machine or using a two-roll mill, may be used.
Blending of at least one polyamide with at least one phenol-carbonyl condensation product in a solvent media.
Dry blending of at least one polyamide with at least one phenol-carbonyl condensation product, in form of fine powders and consolidating them as a single part by melt-compression molding.

The polyamide composition according to the invention comprising the phenol-carbonyl condensation product is especially used as a matrix, notably via granulation, calendering, injection, molding, injection molding or pressing.

It is thus possible for example to prepare granules, chips, pellets, ingots, of all spherical, flat or ovoid shapes, in the form of drops, prisms, parallelepipeds, cylinders or pads.

In particular, when the material is in the form of substantially spherical or ellipsoidal pellets, they can be prepared by an underwater cutting process, as described for example in U.S. Pat. Nos. 2,918,701 and 3,749,539 or else in patent application US 2005/0035483. This process uses a die head provided with holes and fed with the thermoplastic matrix in the melt state, comprising the fillers and optionally one or more additives as described previously. The underwater die head is provided with a rotary knife-holder, the blades of which cut the molten material issuing from the die holes, and the water bath in which the cutting head is submerged allows for rapid cooling of the pellets formed.

To improve the mechanical properties of a polyamide composition according to the invention, it may be advantageous to add thereto at least a reinforcing filler, such as fibrous or non-fibrous fillers, preferably selected from the group consisting of glass fibers, carbon fibers, glass beads, aramid fibers, clays, kaolin, mica, wollastonite, silica, talc, graphite, calcium carbonate, calcium phosphate, silicon carbide and nanoparticles. The level of incorporation of reinforcing and/or bulking filler is in accordance with the standards in the field of composite materials. It may be, for example, an amount of filler of from 1 to 80%, preferably from 10 to 70% and especially between 20 and 60%, with respect to the total weight of the composition.

The polyamide composition may also comprise one or more other polymers, preferably thermoplastic polymers such as polyolefins, ABS or polyester.

The composition according to the invention may also comprise at least one additive usually used for the manufacture of polyamide compositions, chosen from the group consisting of: toughening agents, such as functionalized polyolefins or rubbers, thermal stabilizers, UV stabilizers, chain extenders, lubricants, processing aids, pigments and colorants. Other conventional additives may be used.

For the preparation of a polyamide composition, these fillers and additives may be added to the polyamide via conventional means suited to each filler or additive, for instance during the polymerization or as a molten mixture.

As used herein, the term “resistance to halogen-containing oxidizing agents” refers to retaining the mechanical properties and the surface aspect of a polyamide composition after exposure to halogen-containing oxidizing agents, such as diatomic halogens, halogen radicals, halogen oxides, halogen amines and/or halogen oxoanion salts or their precursors. It also concerns resistance to dimensional changes due to erosion of material from surface, water contamination from eroded products, increased surface roughness affecting flow properties and promoting bacterial growth, and discoloration. It also concerns an improved tensile strength retention of the polyamide composition.

Oxidizing agents refers to substances that have the ability to oxidize other substances, causing them to lose electrons. In the context of polyamide, oxidizing agents usually cause polyamide chain deformation, drop of mechanical properties and an important degradation of surface aspect occurs at the surface of the articles made of polyamide.

Halogen-containing oxidizing agents refers to oxidizing agents comprising at least one halogen atom.

Precursors are intended to refers to molecules able to generate diatomic halogens, halogen radicals, halogen oxides, halogen amines and/or halogen oxoanion salts wherein put in contact with polyamide, notably by disproportionation reaction, inside or outside the polyamide matrix.

Halogen-containing oxidizing agents may be organic or inorganic.

Diatomic halogens are notably I₂, Br₂ and Cl₂. Precursors of diatomic halogens are notably their ionic salts such as NaCl, NaBr, and NaI.

The Halogen radicals may be fluorine radical, chlorine radical, bromine radical, or iodine radical. The radicals may be also be present as halogen oxide radicals such FO*, ClO*, BrO* or IO* or may be halogenate radicals (ClO₃*, BrO₃ or IO₃*), or chlorine dioxide, bromine dioxide or iodine dioxide radicals.

Halogen oxides are notably ClO₂, BrO₂, IO₂, and I₂O₅. Precursors of halogen oxides are notably the hypohalogenites and the corresponding diatomic halogen.

Halogen oxoanion salts are notably chosen in the group consisting of:
Perhalogenate (Oxidation state +7): such as perchlorate (ClO⁻₄), perbromate (BrO⁻₄), and periodate (IO⁻₄);
Halogenate (Oxidation state +5): such as chlorate (ClO⁻₃), bromate (BrO⁻₃), and iodate (IO⁻₃);
Halogenite (Oxidation state +3): such as chlorite (ClO⁻₂), and bromite (BrO⁻₂); and
Hypohalogenite (Oxidation state +1): such as hypochlorite (ClO⁻) and hypobromite (BrO⁻)

Preferably halogen oxoanion salts are alkali metal halogen oxoanion salts; in which alkali metals are the chemical elements found in Group 1 of the periodic table. The alkali metals include: lithium, sodium, potassium, rubidium, cesium, and francium. Halogen oxoanion salts may also be alkaline earth metal halogen oxoanion salts; in which alkali earth metals are the chemical elements found in Group 2 of the periodic table, such as calcium.

More preferably the invention aim to increase resistance to sodium hypochlorite.

Precursors of halogen oxoanion salts are notably the diatomic halogens, reacted with metal hydroxide solutions. Sodium hypochlorite may also be formed from decomposition of chloramines in aqueous media.

Halogen-containing oxidizing agents may also be chosen from halogen amines, such as monochloroamines, dichloroamines, trichloroamines or organochloroamines such as N-chloro tosylamide (Chloramine-T).

Halogen-containing oxidizing agents may notably be bleaching agents having cleaning and or disinfecting properties.

The compositions according to the invention may be used as raw material in the field of plastics processing, for example for the preparation of articles obtained by injection molding, by injection/blow-molding, by extrusion or by extrusion/blow-molding. According to a common embodiment, the polyamide composition is extruded in the form of rods, for example in a twin-screw extrusion device, which are then chopped into granules. Molded components may be prepared by melting the granules produced above and feeding the molten composition into injection-molding devices.

The present invention notably concerns an article manufactured from a composition comprising at least one polyamide and at least one phenol-carbonyl condensation product, having a shape permitting to contain, store and/or transport a liquid.

Halogen-containing oxidizing agents, such as diatomic halogens, halogen radicals, halogen oxides, halogen amines and/or halogen oxoanion salts or their precursors are extensively used for water purification, disinfection and bleaching. Hence, water containing such dissolved chemicals may be present in drinking water purified with chlorine containing chemicals, swimming pool water, water for disinfection at medical facilitites, water for/from bleaching processes in textile and paper industries.

As articles according to the invention, mention may be made of metering device, drum, pump, pipe, plumbing joints/connectors, valves, container, reservoir, tank, vessel, bottle, box, hose, duct and tube, such as for instance cooling tubes, cooling water housings, engine air guide hoses, hoses for the oil circuit. Said articles may be for instance: metering device, drum, pump, pipe, container, reservoir, tank, vessel, bottle, box, hose, duct and tube.

Preferably these articles are produced from a composition as described above by injection molding, by extrusion or by blow molding.

The polyamide composition comprising the phenol-carbonyl condensation product may also be used, as an additive, especially for imparting certain properties, especially rheological properties, to an other compositions comprising as matrix a thermoplastic polymer, especially a (co)polyamide. The polyamide composition comprising the phenol-carbonyl condensation product may also comprise a large proportion of additives and may be used, for example, as a masterbatch intended to be mixed with another thermoplastic composition, especially based on polyamide.

Specific language is used in the description so as to facilitate the understanding of the principle of the invention. It should, however, be understood that no limitation of the scope of the invention is envisioned by the use of this specific language. Modifications, improvements and refinements may especially be envisioned by those skilled in the art of the technical field concerned on the basis of their own general knowledge.

Other details and advantages of the invention will emerge more clearly in the light of the examples below, which are given purely for indicative purposes.

### EXPERIMENTAL SECTION

Sample Preparation
1) Polyamide PA-6,6 (Solvay, Stabamid® 27AE1) or PA-6,10 (Solvay, Stabamid® 28CE2) and variable proportions of Novolac resin (Nowolak® S, LERG S. A., Poland, having a Mw of about 2000 g/mol) were melt blended in a twin-screw extruder (Coperion, ZSK-26 Mc⁺, 12 barrel, L/D 48). Glass fiber (Nippon Electric, Grade 03T-289H) were also added to composition through the 7th barrel of the extruder and carbon black was used as the pigment.
2) Pellets were obtained by chopping rods exiting the extruder, which were dried in an oven for 16 h under vacuum at 100° C.
3) The extruded pellets were molded using an injection molding machine (Sumitomo, SE75EV) into standard bars (tensile specimen, ISO 527) for further studies.
4) The injection molded bars were exposed to aqueous sodium hypochlorite solution of 25 ppm at pH between 6.5 to 7.0, at 85° C., by hanging them in a 2 L glass reactor using TEFLON® threads. During the exposure, the concentration of the aqueous medium decreased, and hence, the concentration of the medium was adjusted every 2 hr by addition of fresh sodium hypochlorite solution, based on measurement of hypochlorite concentration by iodometric titration. At the end of the day, the heating was switched off and next morning the exposure experiement was restarted using fresh solution.

DSC Analysis

The thermal properties of the sample bars of different compositions exposed to the sodium hypochlorite solution for 140 hr in the above mentioned conditions, were measured using DSC (TA-instruments, DSC 2000). For this measurement, samples were collected by scrapping out small amount of material from the surface of a portion of each test bar, which were dried under vacuum at 100° C. DSC of the samples were run at 20° C./min in the temperature range of 0° C. to 280° C. The first cooling cycle and the second heating cycle were considered for measurement of the melting (Tm) and crystallization (Tc) temperature of the materials.

Results are expressed in Table 1.

TABLE 1

| Samples | Tm | Tc |
|---|---|---|
| 50% PA-66 + 50% GF | 262 | 232 |
| (Non-Exposed) | | |
| 50% PA-66 + 50% GF | 234 | 206 |
| (Exposed) | | |
| 40% PA-66 + 50% GF + | 258 | 227 |
| 10% Novolac | | |
| (Non-Exposed) | | |
| 40% PA-66 + 50% GF + | 254 | 229 |
| 10% Novolac | | |
| (Exposed) | | |
| 50% PA-6,10 + 50% GF | 221 | 193 |
| (Non-Exposed) | | |
| 50% PA-6,10 + 50% GF | 208 | not measured |
| (Exposed) | | |
| 40% PA-6,10 + 50% GF + | 219 | 187 |
| 10% Novolac | | |
| (Non-Exposed) | | |
| 40% PA-6,10 + 50% GF + | 217 | 190 |
| 10% Novolac | | |
| (Exposed) | | |

% is expressed by weight

It appears then that the surface of the polyamide bars not protected by Novolac and exposed with hypochlorite solution have degraded layer by layer, leading to a decrease in Tm/Tc. In contrast, polyamide bars protected by Novolac have a higher hypochlorite resistance, substantially maintaining the Tm and Tc of the polyamide.

Visual Observation

Observations on the test bars exposed to the aqueous solution comprising 25 ppm of sodium hypochlorite at 85° C., were made at different intervals of time, using an optical microscope (Zeiss, Stemi 2000C) at a magnification of ×125. The micrographs were recorded and rated in terms of extent of exposure of glass fibers on the surface due to the polyamide degradation. An image processing and analysis software (ImageJ, NIH, USA) was used on the gray-scale images, by binarization at a constant threshold and measurement of the percentage white area, ascribed to the exposed glass fibers. The numbers obtained could be grouped into three categories Good, Bad & Very bad, as per the following criteria:
Very Bad: Percent area=40% or above
Bad: Percent area=above 20-40%
Good: Percent area=0-20%
   Results are expressed in Table 2.

TABLE 2

| Samples | 0 hrs | 75 hrs | 170 hrs | 325 hrs |
|---|---|---|---|---|
| 50% PA-66 + | Good | Bad | Very bad | Very bad |
| 50% GF | (8) | (33) | (61) | (54) |
| (Exposed) | | | | |
| 40% PA-66 + | Good | Good | Bad | Bad |
| 50% GF + | (10) | (7) | (26) | (35) |
| 10% Novolac | | | | |
| (Exposed) | | | | |
| 50% PA-610 + | Good | Very bad | Very bad | Very Bad |
| 50% GF | (5) | (46) | (61) | (60) |
| (Exposed) | | | | |
| 40% PA-610 + | Good | Good | Bad | Bad |
| 50% GF + | (1) | (9) | (26) | (34) |
| 10% Novolac | | | | |
| (Exposed) | | | | |

% is expressed by weight

L* Value (Lightness Index)

Bars were tested in presence of an aqueous solution comprising 25 ppm of sodium hypochlorite at 60° C. for 35, 75, 200 or 325 hrs. L* Value (whitening) was measured by placing the exposed bars, after drying off the surface water, on the sample holder (apparture of 0.6 cm) of a spectrophotometer for colour measurement (Colour i7, X-Rite).

Results are expressed in Table 3.

TABLE 3

| | L* Value | L* Value | L* Value | L* Value |
|---|---|---|---|---|
| Samples | 35 hrs | 75 hrs | 200 hrs | 325 hrs |
| 50% PA-610 + 50% GF | 27 | 28 | 41 | 49 |
| (Exposed) | | | | |
| 45% PA-610 + | 27 | 28 | 31 | 38 |
| 50% GF + 5% Novolac | | | | |
| (Exposed) | | | | |
| 40% PA-610 + | 27 | 28 | 29 | 31 |
| 50% GF + 10% Novolac | | | | |
| (Exposed) | | | | |
| 50% PA-66 + 50% GF | 27 | 31 | 37 | 39 |
| (Exposed) | | | | |
| 45% PA-66 + 50% GF + | 27 | 27 | 30 | 31 |
| 5% Novolac | | | | |
| (Exposed) | | | | |
| 40% PA-66 + 50% GF + | 27 | 28 | 28 | 28 |
| 10% Novolac | | | | |
| (Exposed) | | | | |

% is expressed by weight

It appears then that the surface of the polyamide sample bars not protected by Novolac and exposed with hypochlorite solution have been degraded, leading to an increase of L* Value due to greater amount of exposed glass fibers on the surface. In contrast, polyamide bars protected by Novolac have a higher hypochlorite resistance with a lower increase of L* Value.

Kinetic Study of NaOCl Consumption Rate

A kinetic study of NaOCl consumption rate with polyamide compositions as previously prepared was carried out as follows: Four injection molded plates [50 mm×20 mm×2.5 mm] for each of the compositions were kept in a conical flask, containing 550 ml of 25 ppm aqueous hypochlorite solution at 85° C., placed in water bath. The concentration of sodium hypochlorite in the flask was measured by taking out aliquot from the flask at different intervals of time using iodometric titration.

Results are expressed in Table 4.

TABLE 4

| | | 40% PA-66 + | 50% PA- | 40% PA-610 + |
|---|---|---|---|---|
| | 50% PA-66 + | 50% GF + | 610 + | 50% GF + |
| Time | 50% GF | 10% Novolac | 50% GF | 10% Novolac |
| (min) | (ppm) | (ppm) | (ppm) | (ppm) |
| 0 | 21.7 | 22.3 | 23.2 | 23.1 |
| 30 | 15.4 | 1.4 | 18.3 | 6.9 |
| 60 | 11.4 | 0.0 | 15.0 | 1.3 |
| 90 | 9.3 | 0.0 | 12.3 | 0.5 |
| 120 | 6.0 | 0.0 | 9.4 | 0.0 |
| 150 | 4.0 | 0.0 | 6.5 | 0.0 |
| 180 | 2.4 | 0.0 | 4.4 | 0.0 |
| 210 | 1.2 | 0.0 | 2.5 | 0.0 |
| 240 | 0.5 | 0.0 | 1.3 | 0.0 |

% is expressed by weight

It appears then that there is a fast consumption of NaOCl with the polyamide composition containing novolac of the present invention in comparison with polyamide compositions of the prior art. This implies that presence of novolac decreases the concentration of NaOCl at the surface of the material before it can react with the polyamide molecules.

Tensile Strength Property

Bars were tested in presence of chlorinated water at different temperatures 23° C. and 85° C. The water is monitored to adjust chlorine level at 5 ppm of NaOCl (sodium hypochlorite), pH at 7 and temperature. The materials were evaluated through tensile measurements after different aging times in this controlled environment.

Results are expressed in Table 5 and Table 6.

TABLE 5
Water 23° C./5 ppm [NaOCl]/pH 7
Tensile Strength (MPa)/time (hours)

| | | | | | | Final |
|---|---|---|---|---|---|---|
| | | | | | | reten- |
| | 0 | 1000 | 2500 | 3500 | 4500 | tion (%) |
| 50% PA-66 + 50% GF | 224 | 143.5 | 124 | 120 | 119 | 53 |
| 40% PA-66 + 50% GF + | 232 | 179.5 | 158 | 147 | 142 | 61 |
| 10% Novolac | | | | | | |
| 50% PA-610 + 50% GF | 193 | 151.8 | 140 | 130 | 131 | 68 |
| 40% PA-610 + 50% GF + | 207 | 169.3 | 157 | 150 | 146 | 71 |
| 10% Novolac | | | | | | |

% is expressed by weight

TABLE 6
Water 85° C./5 ppm [NaOCl]/pH 7
Tensile Strength (MPa)/time (hours)

| | | | | | Final |
|---|---|---|---|---|---|
| | | | | | retention |
| | 0 | 600 | 1000 | 2000 | (%) |
| 50% PA-66 + | 224 | 132 | 120 | 82 | 37 |
| 50% GF | | | | | |
| 45% PA-66 + | 232 | 148 | 145 | 107 | 46 |
| 50% GF + | | | | | |
| 5% Novolac | | | | | |
| 50% PA-610 + | 193 | 141 | 136 | 100 | 52 |
| 50% GF | | | | | |
| 45% PA-610 + | 207 | 154 | 152 | 124 | 60 |
| 50% GF + | | | | | |
| 5% Novolac | | | | | |

% is expressed by weight

It appears that the polyamide sample bars protected by novolac and exposed with hypochlorite solution have higher tensile strength retention as compared to the bars without novolac.

1. A method for increasing a polymide-containing composition's resistance to halogen-containing oxidizing agents, the method comprising:
blending the polyamide with at least one phenol-carbonyl condensation product.

2. The method according to claim 1 wherein the polyamide is either a semicrystalline or an amorphous (co)polyamide.

3. The method according to claim 1, wherein the polyamide is selected from the group consisting of the polyamides obtained by polycondensation of:
at least one aliphatic, cycloaliphatic or aromatic diacid with at least one aliphatic, cycloaliphatic or aromatic diamine,
at least one amino acid to itself, the amino acid preferably being an omega aminoacid generated by opening of a lactam ring, or
copolyamides obtained by the polycondensation of combinations of said diacid, diamine and/or aminoacid.

4. The method according to claim 3, wherein at least one of the diacid, diamine and/or aminoacid monomer used in the polycondensation comprises between 2 and 40 carbon atoms.

5. The method according to claim 1, wherein the polyamide is chosen from the group consisting of (co)polyamides as follows: polyamide 6, polyamide 7, polyamide 6.6, polyamide 10, polyamide 11, polyamide 12, polyamide 6.9, polyamide 5.10, polyamide 6.10, polyamide 6.12, polyamide 6.14, polyamide 10.10, polyamide 10.12, polyamide 10.14, polyamide 10.18, polyamide 12.12, polyamide 4.6, polyamide 6.18, polyamide 6.36, polyamide 9.T, polyamide MXD6, polyamide 6.6/6.T, polyamide 6.6/MPMD.T, polyamide 66.61 and blends and copolymers based on these polyamides.

6. The method according to claim 1, wherein the phenol-carbonyl condensation product is chosen from the group consisting of: phenol-aldehyde condensation products and phenol-ketone condensation products.

7. The method according to claim 1, wherein the phenol-carbonyl condensation product has an average molecular weight comprised between 500 and 3000 g/mol.

8. The method according to claim 1, wherein the phenol-carbonyl condensation product is a novolac resin or a resole resin.

9. The method according to claim 1, wherein the composition comprises from 0.1% to 30% by weight, preferably from 1 to 20% by weight, of the phenol-carbonyl condensation product relative to the total weight of the polyamide and the phenol-carbonyl condensation product.

10. The method according to claim 1, wherein the composition comprises from 70% to 99.9% by weight, preferably from 80 to 99% by weight, of the polyamide relative to the total weight of the polyamide and the phenol-carbonyl condensation product.

11. The method according to claim 1, wherein the composition comprises a reinforcing filler.

12. The method according to claim 1, wherein the composition comprises a reinforcing and/or bulking filler selected from the group consisting of: glass fibers, carbon fibers, glass beads, aramid fibers, clays, kaolin, mica, wollastonite, silica, talc, graphite, calcium carbonate, calcium phosphate, silicon carbide and nanoparticles.

13. The method according to claim 1, wherein the composition comprises at least one additive chosen from the group consisting of: toughening agents, such as functionalized polyolefins or rubbers, thermal stabilizers, UV stabilizers, chain extenders, lubricants, processing aids, pigments and colorants.

14. An article manufactured from a composition comprising at least one polyamide and at least one phenol-carbonyl condensation product, the article having a shape that permits it to contain, store and/or transport a liquid.

15. The article according to claim 14, wherein the article is selected from the group consisting of metering device, drum, pump, pipe, container, reservoir, tank, vessel, bottle, box, hose, duct and tube.

16. The article according to claim 14, wherein the article is produced by injection molding, by extrusion or by blow molding.

17. (canceled)

18. (canceled)
